(19) United States
(12) Patent Application Publication
(10) Pub. No.: US 2014/0083593 A1
(43) Pub. Date: Mar. 27, 2014

(54) APPARATUS AND METHOD FOR MANUFACTURING DISPLAY DEVICE

(71) Applicant: KABUSHIKI KAISHA TOSHIBA, Tokyo (JP)

(72) Inventors: Kentaro MIYAZAKI, Yokohama-shi (JP); Takeshi Toyoshima, Yokohama-shi (JP); Shouichiro Aramaki, Kawasaki-shi (JP)

(73) Assignee: KABUSHIKI KAISHA TOSHIBA, Tokyo (JP)

(21) Appl. No.: 13/803,867

(22) Filed: Mar. 14, 2013

(30) Foreign Application Priority Data
Sep. 24, 2012 (JP) 2012-209132

(51) Int. Cl. B32B 41/00

(52) U.S. Cl. CPC B32B 41/00
USPC 156/64; 156/350

(57) ABSTRACT

An apparatus for manufacturing a display device, the apparatus includes, a drive mechanism for joining together a first substrate and a second substrate with an adhesive intervening between them by causing a first substrate retention unit and a second substrate retention unit to relatively approach each other, a measurement unit for measuring a gap between the first substrate and the second substrate, and a control unit for causing the gap between the first substrate and the second substrate to approach to a design value by means of the drive mechanism, and, after a predetermined period elapses, causing the gap between the first substrate and the second substrate to be apart at the design value by means of the drive mechanism on the basis of a value measured by the measurement unit.

### CROSS-REFERENCE TO RELATED APPLICATIONS

This application is based upon and claims the benefit of priority from Japanese Patent Application No. 2012-209132, filed Sep. 24, 2012, the entire contents of which are incorporated herein by reference.

### FIELD

Embodiments described herein relate generally to an apparatus and a method both for manufacturing a display device.

### BACKGROUND

Manufacture of a display device includes a step of joining together two transparent plate members (also referred to as “substrates” hereinafter). Apparatuses for joining them employ two methods, that is, a method of using an adhesive sheet, and that of using a resin adhesive. The adhesive sheet costs more than the adhesive, and therefore the method of joining them using a resin adhesive is mainly employed because of increasingly strong demands for cost reduction in recent years.

A known method of the joining is to coat a plurality of places on a contact surface of a work A with an adhesive, and cause the contact surface to contact with another sheet of the work B so as to fill the adhesive by virtue of the own weight of the work A.

### BRIEF DESCRIPTION OF THE DRAWINGS

FIG. 1 is a side view diagram illustrating a manufacture apparatus according to an embodiment, the apparatus for manufacturing a display device;

FIG. 2 is a plan view diagram illustrating the manufacture apparatus for manufacturing the display device;

FIG. 3 is a side view diagram illustrating a press-in step related to the manufacture apparatus for manufacturing the display device;

FIG. 4 is a side view diagram illustrating a display device produced by the manufacture apparatus for manufacturing the display device;

FIG. 5 is a description diagram showing an operation flow in the manufacture process related to the manufacture apparatus for manufacturing the display device;

FIG. 6 is a description diagram showing an operation principle of the manufacture apparatus for manufacturing the display device;

FIG. 7 is a description diagram showing positions of a stage as a function of time in the respective steps related to the manufacture apparatus for manufacturing the display device; and

FIG. 8 is a description diagram showing an operation principle related to the manufacture apparatus for manufacturing the display device.

### DETAILED DESCRIPTION

An apparatus for manufacturing a display device according to an embodiment, the apparatus includes: a first substrate retention unit for retaining a first substrate; a second substrate retention unit for retaining a second substrate; a drive mechanism for joining together the first substrate and the second substrate with an adhesive intervening between them by causing the first substrate retention unit and the second substrate retention unit to relatively approach each other in a predetermined approach speed; a measurement unit for measuring a gap between the first substrate and the second substrate; and a control unit for causing the gap between the first substrate and the second substrate to reach a design value by means of the drive mechanism, and, after a predetermined period elapses, causing the gap between the first substrate and the second substrate to be apart at the design value by means of the drive mechanism on the basis of a value measured by the measurement unit.

The following is a description of the present embodiment in detail with reference to the accompanying drawings.

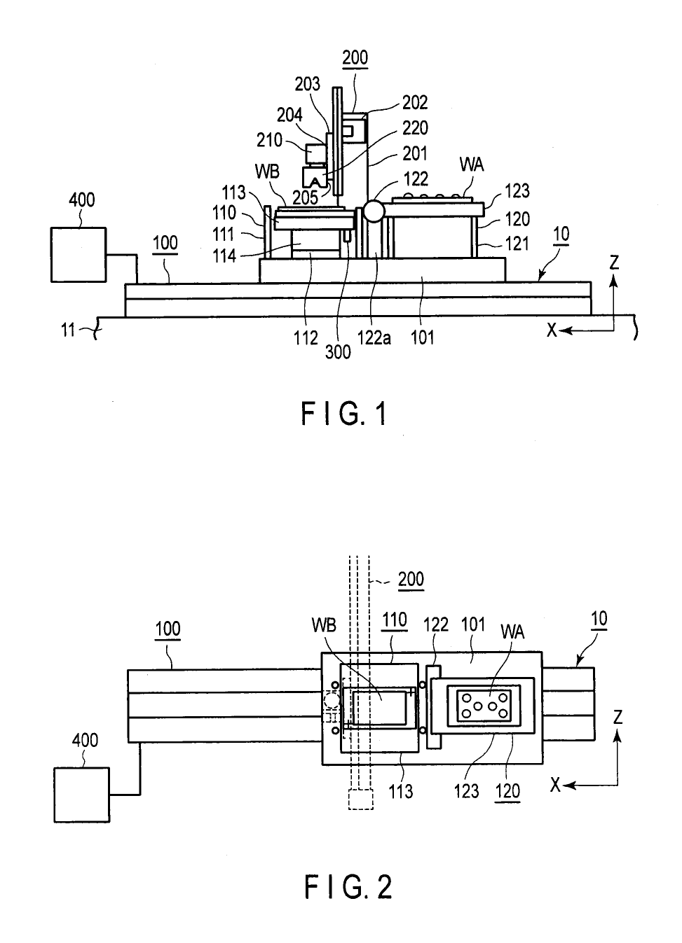

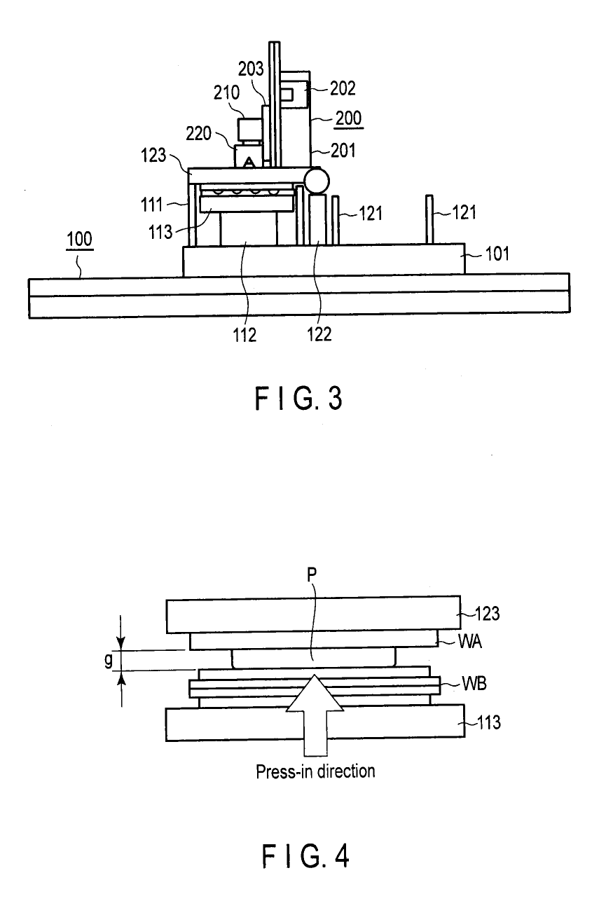

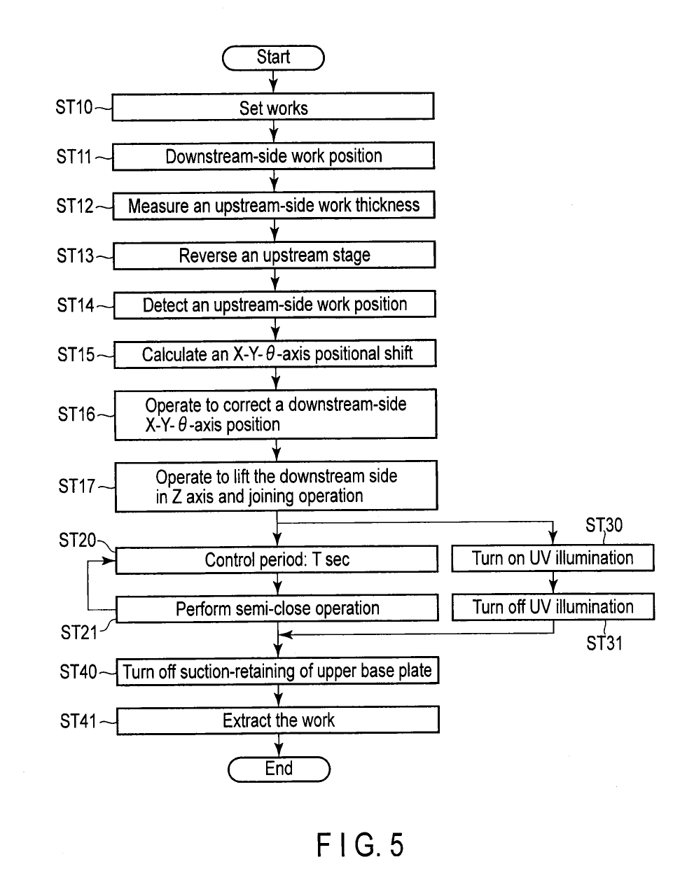

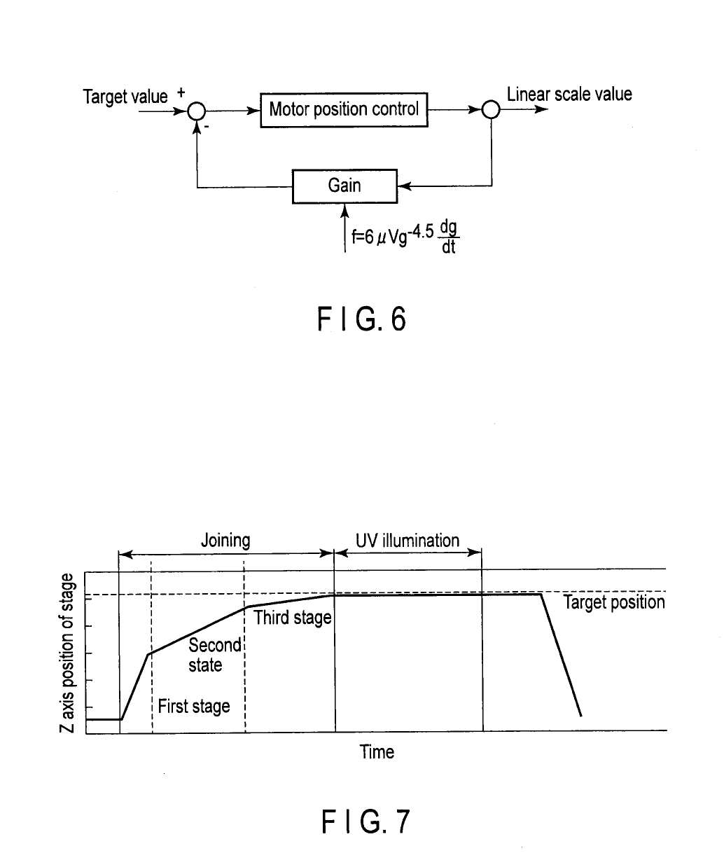

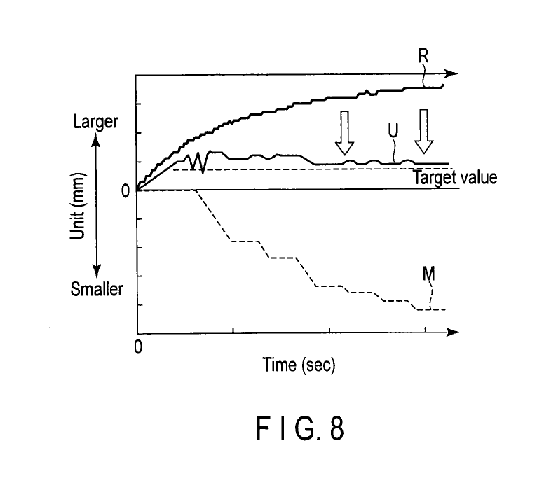

FIG. 1 is a side view diagram illustrating a joining apparatus 10 (that is equivalent to a manufacture apparatus for manufacturing a display device; this note is not given in the following descriptions) according to an embodiment of the present invention; FIG. 2 is a plan view diagram illustrating the joining apparatus 10; FIG. 3 is a side view diagram illustrating a press-in step related to the joining apparatus 10; FIG. 4 is a side view diagram illustrating a display device produced by the joining apparatus 10; FIG. 5 is a description diagram showing an operation flow in the manufacture process related to the joining apparatus 10; FIG. 6 is a description diagram showing an operation principle of the joining apparatus 10; FIG. 7 is a description diagram showing positions of a stage as a function of time in the respective steps related to the joining apparatus 10; and FIG. 8 is a description diagram showing an operation principle related to the joining apparatus 10.

It is noted that the arrows “X”, “Y”, and “Z” shown in these figures indicate three mutually orthogonal directions, with a “X, Y” direction indicating a horizontal direction, while a “Z” direction indicating a vertical direction. Further, “θ” indicates a rotational angle around a Z direction. Further, “WA” shown in these figures indicates an upstream-side work (that is equivalent to an example of the first substrate; this note is not given in the following descriptions), while “WB” shown likewise indicates a downstream-side work (that is equivalent to an example of the second substrate; this note is not given in the following descriptions). Each of the downstream-side work WB and the upstream-side work WA is, for example, a substrate such as a cover glass, a sensor glass, a substrate of a liquid crystal module. Furthermore, an adhesive to be used is, for example, an ultraviolet curable adhesive P. Furthermore, a gap between the downstream-side work WB and the upstream-side work WA is indicated by “g”.

The joining apparatus 10 is provided with a base table 11 that is stationarily placed on a floor surface. An X-direction guide mechanism 100 extending in an X direction and a measurement mechanism 200 are mounted on the base table 11. Further, the joining apparatus 10 is provided with a control unit 400 for controlling the X-direction guide mechanism 100 and the measurement mechanism 200 in connection with each other.

The X-direction guide mechanism 100 is provided with a stage 101 whose position in an X direction is determined by the X-direction guide mechanism 100.

The stage 101 is provided thereon with a lower substrate mounting mechanism 110 and an upper substrate mounting mechanism 120 in parallel with each other in the X direction.

The lower substrate mounting mechanism 110 includes: a reference support unit 111 constituted by four columns mounted onto the stage 101; an alignment mechanism 112 that is disposed at a position enclosed by the reference support unit 111 and performs alignment in X-Y-Z-θ directions; and a downstream-side stage 113 that is supported by the alignment mechanism 112 and suction-retains the downstream-side work WB. The downstream-side stage 113 is subjected to a fine adjustment performed by the alignment mechanism 112 in X-Y-θ directions. It is noted that a drive mechanism 114 that moves up and down in the Z directions is supported by the alignment mechanism 112.

The upper substrate mounting mechanism 120 includes: a reference support unit 121 constituted by four columns disposed on the stage 101; a reverse mechanism 122 disposed between the reference support unit 111 and the reference support unit 121; and an upstream-side stage 123 that is supported by the reverse mechanism 122 and suction-retains the upstream-side work WA. The upstream-side stage 123 is configured to be allowed to freely move between on the reference support unit 121 and above the downstream-side stage 113 in a swinging manner by means of the reverse mechanism 122.

The measurement mechanism 200 includes: a support column 201 disposed on the base table 11 in the Z direction; a Y-direction guide mechanism 202 extending from the support column 201 in a Y direction; and a stage 203 whose position is subjected to determination in a Y direction by the Y-direction guide mechanism 202. Further, the stage 203 supports a camera guide mechanism 204 and a laser displacement meter guide mechanism 205. Further, a linear scale 300 is provided for measuring the gap g between the upstream-side work WA and the downstream-side work WB. The linear scale may be disposed on the downstream-side stage 113, and particularly be disposed at a predetermined position nearby the drive mechanism 114 as shown in FIG. 1.

The camera guide mechanism 204 is equipped with a camera unit 210 that has a downward direction as its imaging range and is subjected to determination of a position in Z directions. As described in detail later, the camera unit 210 has functionality of recognizing respective images of the downstream-side work WB and the upstream-side work WA to highly accurately measure positions of the downstream-side work WB and the upstream-side work WA. Meanwhile, the laser displacement meter guide mechanism 205 is equipped with a laser displacement meter unit 220 that has a downward direction as its measurement direction and of which a position is subjected to determination in Z directions. The laser displacement meter unit 220 has functionality of illuminating a laser beam on the downstream-side work WB and the upstream-side work WA to highly accurately measure a thickness of the work WB and that of the work WA in a noncontact manner.

FIG. 6 shows a principle of controlling a position of a motor of the drive mechanism 114 on the basis of a measurement value of the linear scale 300. That is, the difference between the target value of the gap g and the measurement value of the linear scale 300 multiplied by a predetermined gain to determine the position of the motor of the drive mechanism 114. It is appreciated that a use of a value proportionate with reactive force f for the gain, instead of using a predetermined value, prevents hunting on the control.

On thus configured joining apparatus 10, the substrate WB and the substrate WA are joined together. First, the downstream-side work WB and the upstream-side work WA are respectively placed on the downstream-side stage 113 and the upstream-side stage 123, and are suction-retained onto the respective stages (ST10). It is noted that the adhesive P is coated on a predetermined location or locations of the upstream-side work WA.

Next, the downstream-side work WB is moved to under the camera unit 210 to detect a position of the downstream-side work WB, and then the downstream-side work WB is moved to under the laser displacement meter unit 220 to measure a thickness of the downstream-side work WB (ST11).

Next, the upstream-side work WA is moved to under the laser displacement meter unit 220 to measure a thickness of the upstream-side work WA (ST12).

Next, as shown in FIG. 3, the reverse mechanism 122 is operated to turn the upstream-side stage 123 to move the upstream-side work WA to above the downstream-side work WB with the upstream-side work WA suction-retained to the upstream-side stage 123 (ST13).

Next, the upstream-side work WA is moved to under the camera unit 210 to detect a position of the upstream-side work WA (ST14).

In this event, a positional shift between the downstream-side work WB and the upstream-side work WA is calculated (ST15). The alignment mechanism 112 is operated to correct the positional shift in X-Y-θ axes (ST16).

When the correction of the positional shift is completed, the drive mechanism 114 is put to operate to lift the downstream-side work WB to perform a joining operation (ST17). A target value of the gap g between the upstream-side work WA and the downstream-side work WB is set at a design value in this event. In the joining operation, for example, the ascending speed of the drive mechanism 114 is adjusted in three steps to reach a target position in a short period of time and suppress occurrence of reactive force f (described later) to a minimum as shown in FIG. 7.

In the joining operation, force is applied in a direction to reduce the volume of the adhesive P, the reactive force f is applied from it to the upstream-side work WA and the downstream-side work WB. The reactive force f is given by the following expression 1:

F=6 Vg^{-4/5}dg/dt (Expression 1),

where “Vg” is a volume, “dg/dt” is an approach speed, “μ” is a constant determined for each coating condition on the basis of viscosity, volume, and other properties, of the adhesive P.

The reactive force f is transmitted from the upstream-side work WA and the downstream-side work WB, to the drive mechanism 114, and downstream-side stage 113 and upstream-side stage 123, causing the aforementioned components to be respectively deflected. While the deflections themselves will disappear when the approaching is stopped to eliminate the reactive force f, it will, however, take anywhere from several milliseconds to a few seconds for the deflections to disappear. In the meantime, the gap g between the upstream-side work WA and the downstream-side work WB will further narrows, deviating from the design value (“R” shown in FIG. 8 is referred to).

It is noted that the present step allows a predetermined period of standby in this event. The predetermined period is predetermined by predicting a period of time for the upstream-side work WA, the downstream-side work WB, the drive mechanism 114, the downstream-side stage 113, and the upstream-side stage 123 being deflected by the reactive force f to be eliminated.

Within the predetermined period, an amount of shift is measured with the linear scale 300 on which a control cycle T is set (ST20), and the drive mechanism 114 is moved in a reverse direction (i.e., downward in viewing FIG. 1) by a distance equivalent to the amount of shift (ST21). With reference to FIG. 8, it is noted that “R” denotes an amount of shift, “M” denotes an amount of reverse of the drive mechanism 114, “U” denotes the gap g between the upstream-side work WA and the downstream-side work WB after adjustment by the control, eventually falling in a predetermined error limits relative to the design value.

As described above, it takes a few minutes to eliminate the influence of the reactive force f and therefore the gap g will be stabilized relative to the design value approximately in 5 to 6 seconds according to a case exemplified in FIG. 8.

In the meantime, while the amount of shift is calculated and adjusted as described above, a parallel step is performed to provisionally cure the adhesive P (ST30 and ST31).

When the parallel steps are completed, the suction-retaining of the upstream-side work WA is stopped (ST40) to extract the upstream-side work WA and downstream-side work WB (ST41), thus the joining operation is completed.

The joining apparatus 10 according to the present embodiment is capable of adjusting the gap g between the upstream-side work WA and the downstream-side work WB by means of the drive mechanism 114, the gap g that once reaches the design value, is then decreased due to deflections of the downstream-side work WB, the drive mechanism 114, the downstream-side stage 113, and the upstream-side stage 123, and further is decreased by the deflections being decreased, all caused by the reactive force f generated in the joining operation, thereby making it possible to set the gap g at the design value.

It is appreciated that the above described configuration is capable of causing the gap g to reach the design value in a shorter period (i.e., a few seconds) compared to a processing period (e.g., tens of seconds) according to a case where the gap g is controlled to slowly reach the design value on the basis of a prediction of an amount of deflection in advance. Therefore, the present configuration is capable of not only reducing a tact time of the joining step but also highly accurately controlling the thickness of the adhesive layer, realizing a high-quality joining.

According to the present invention, the display device exemplifies a liquid crystal display device and an organic electro-luminescent (EL) display device, while the adhesive allows usage of any adhesive materials that are within the scope and spirit of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for manufacturing a display device, the apparatus comprising:
a first substrate retention unit for retaining a first substrate;
a second substrate retention unit for retaining a second substrate;
a drive mechanism for joining together the first substrate and the second substrate with an adhesive intervening between them by causing the first substrate retention unit and the second substrate retention unit to relatively approach each other in a predetermined approach speed;
a measurement unit for measuring a gap between the first substrate and the second substrate; and
a control unit for causing the gap between the first substrate and the second substrate to approach to a design value by means of the drive mechanism, and, after a predetermined period elapses, causing the gap between the first substrate and the second substrate to be apart at the design value by means of the drive mechanism on the basis of a value measured by the measurement unit.

2. The apparatus for manufacturing a display device according to claim 1,
wherein the predetermined period is determined on the basis of a period of time in which amounts of deflections of the drive mechanism, the first substrate retention unit, the second substrate retention unit, the first substrate, the second substrate and the adhesive, the deflections caused by reactive force generated in at least the aforementioned components, respectively recover when a gap between the first substrate and the second substrate is caused to approach to the design value by means of the drive mechanism.

3. A method for manufacturing a display device, the method for joining together a first substrate and a second substrate, the first and second substrates being respectively retained by a first substrate retention unit and a second substrate retention unit, the method comprising:
coating at least either one of the first substrate and the second substrate with an adhesive;
causing the first substrate retention unit and the second substrate retention unit to approach each other in a predetermined approach speed so that a gap between the first substrate and the second substrate reaches a design value;
measuring a gap between the first substrate and the second substrate when a predetermined period elapses; and
causing the gap between the first substrate and the second substrate to be apart at the design value.

4. The method for manufacturing a display device according to claim 3,
wherein the predetermined period is determined on the basis of a period of time in which amounts of deflections of the first substrate retention unit, the second substrate retention unit, the first substrate, the second substrate and the adhesive, the deflections caused by reactive force generated in at least the aforementioned components, recover when a gap between the first substrate and the second substrate is caused to approach to the design value.
